(19) United States
(12) Patent Application Publication
(10) Pub. No.: US 2012/0267586 A1
(43) Pub. Date: Oct. 25, 2012

(54) PULLER FOR CONCRETE FORM STAKES

(76) Inventor: Joseph Andrew Brown, Woodacre, CA (US)

(21) Appl. No.: 13/092,672

(22) Filed: Apr. 22, 2011

(51) Int. Cl. B66F 19/00; B23P 19/04

(52) U.S. Cl. 254/30; 29/426.5

(57) ABSTRACT

A stake puller for extracting a stake from a portion of a substrate (e.g., earth, soil, or the like) wherein the stake is abutted against a perpendicular wall that thereby exposes a side portion of the stake opposite of the perpendicular wall between the portion of the substrate and an exposed top of the stake, the puller including: a shaft having a distal end and a proximal end; a cross-handle coupled to the proximal end; and a stake-engaging head, coupled to the distal end, engaging the exposed side portion of the stake between the portion of the substrate and the exposed top from a direction opposite of the perpendicular wall wherein a longitudinal axis of the shaft is generally parallel to a longitudinal axis of the stake when the stake-engaging head engages the exposed side portion of the stake.

### BACKGROUND OF THE INVENTION

The present invention relates generally to stake removal, and more specifically, but not exclusively, to removing concrete-form-retaining stakes from the ground.

Stakes are used extensively in the concrete construction trade. The stakes are commonly cylindrical in shape and made from metal, although other materials like wood or plastic may be used. When concrete is poured, it is in a semi-liquid state and forms are required to constrain the concrete to a desired boundary. The stakes, which are driven into the ground with a sledgehammer, hold the forms in place while the concrete dries.

Once the concrete has hardened, the stakes must be pulled from the ground so the forms may be removed. Currently, this is a very laborious and time consuming task caused, primarily, by four factors. First, the stakes are driven deep into hard-packed soil, often to a depth of 12+inches. A great deal of physical effort is required to free the stake from the ground and, with the primitive tools currently available, it is often easier to simply abandon the stake by cutting it off at the ground's surface. The loss of stakes in this manner adds an additional penalty to an already costly process. Second, pouring the concrete into the form necessarily results in the form being pressed hard against the stake. After hardening, the concrete holds the form tightly against the stake completely obstructing access to the stake except from opposite the form. Third, the stakes are usually round and rigid, further decreasing an ability of a tool to engage the stake. Fourth, the large quantity of stakes required for the average construction project amplifies the stake removal problem. Even a small improvement over existing methods adds up to a significant time savings when several hundred stakes must be pulled.

FIG. 1 illustrates a side plan view of a representative stake installation 100 and FIG. 2 illustrates a front plan view of installation 100. FIG. 1 and FIG. 2 illustrate a typical configuration 100 for a post-pour context of preferred embodiments of the present invention. A concrete form 105 retains a quantity of concrete 110 by use of a plurality of stakes 115 driven into a section of a substrate (e.g., earth, soil, or the like) 120. Forms are adapted to suit many different situations and there is a great range to the layout of the forms, and as such there can be portions of the form that are very difficult to access, particularly with certain tools because of uneven ground or forms placed close to other forms or other structures.

There have been many different solutions to the problems of stake removal in general as well as removal of concrete form retaining stakes. There are deficiencies when using a general purpose post removal solution for this type of concrete form stake and tools for removing concrete form stakes are not as optimally efficient in time or as versatile as desired when locating the puller for certain stake positions. Challenges have been conveniently and quickly (re)locating the tool, efficiently and quickly engaging the stake with the tool, and efficiently extracting the stake with the tool.

What is needed is an improved stake puller that overcomes the limitations of the existing devices.

### BRIEF SUMMARY OF THE INVENTION

Disclosed is an improved stake puller that overcomes the limitations of the existing devices. The following summary of the invention is provided to facilitate an understanding of some of technical features related to stake pulling in the context of retaining stakes for concrete forms, and is not intended to be a full description of the present invention. A full appreciation of the various aspects of the invention can be gained by taking the entire specification, claims, drawings, and abstract as a whole.

A stake puller for extracting a stake from a portion of a substrate (e.g., earth, soil, or the like) wherein the stake is abutted against a perpendicular wall that thereby exposes a side portion of the stake opposite of the perpendicular wall between the portion of the substrate and an exposed top of the stake, the puller including: a shaft having a distal end and a proximal end; a cross-handle coupled to the proximal end; and a stake-engaging head, coupled to the distal end, engaging the exposed side portion of the stake between the portion of the substrate and the exposed top from a direction opposite of the perpendicular wall wherein a longitudinal axis of the shaft is generally parallel to a longitudinal axis of the stake when the stake-engaging head engages the exposed side portion of the stake.

A method for extracting a stake from a portion of the substrate wherein the stake is abutted against a perpendicular wall that thereby exposes a side portion of the stake opposite of the perpendicular wall between the portion of the substrate and an exposed top of the stake, the method including: a) engaging the exposed side portion of the stake between the portion of the substrate and the exposed top from a direction opposite of the perpendicular wall with an engagement head coupled to a distal end of a shaft with a longitudinal axis of the shaft generally parallel to a longitudinal axis of the stake; b) applying a longitudinal force to the shaft directed away from the portion of the substrate; and c) transferring the longitudinal force to the stake through the coupling of the engagement head to the shaft.

The preferred embodiments disclosed herein are described in the context of a extracting form-retaining stakes, particularly stakes holding concrete forms in position. There are two principle mechanical implementations, a “manual” model and a “pressure-driven” model. The manual model is efficient in terms of being able to locate a stake engagement head in virtually any location as it does not use or require any base or contact to leverage against (it is completely suspended above the ground by the user). For some stakes, the grip of the engagement head mechanically advantaged by the length of the shaft permits some stakes to be extracted simply by pulling, rocking and the like on the handle (which longitudinally pulls the stakes as well, improving its efficiency). Some stakes require additional extraction force and that is provided by operation of a slide hammer or the like coupled to the shaft. The user operates the slide hammer with the engagement head engaged to forcibly drive out the stake. The engagement head includes an exposed open channel for gripping an exposed side of a stake abutted against a form or other perpendicular wall. The construction is such that the harder one pulls at the stake, the stronger the engagement head grips the stake. The channel is open and permits a very long stake to be extracted by pulling a stake out part way and then re-engaging the stake closer to the ground and extracting more of the stake by similar operation.

The pressure-driven model uses some fluid (e.g., hydraulic liquid or compressed gas) to drive a motor (e.g., a piston or the like) coupled to the engagement head. This embodiment includes a base for supporting the tool on the ground, the top of a form, or other stable foundation, and pulls the stake by operating against the base. In the preferred embodiment, this model uses an external reservoir of fluid (e.g., an air compressor or hydraulic system of a piece of construction equipment such as excavation machinery) coupled to the tool by a hose or tube. Preferably the tool is operable by a single user which means that at least one control valve is directly coupled to the tool. In some implementations, it may be efficient to have a pair of users extracting stakes—for example one sits in the cab of the machinery and controls the fluid flow to the tool and the other moves and positions the tool at each stake.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a side plan view of a representative stake installation;

FIG. 2 illustrates a front plan view of the representative stake installation shown in FIG. 1;

FIG. 3-FIG. 5 illustrate a preferred embodiment for a manual mode stake extraction tool useable in the stake installation shown in FIG. 1 and FIG. 2;

FIG. 3 illustrates a back view of the tool;

FIG. 4 illustrates a side view of the tool;

FIG. 5 illustrates a front view of the tool;

FIG. 6-FIG. 8 illustrate a preferred embodiment for a pressurized mode stake extraction tool useable in the stake installation shown in FIG. 1 and FIG. 2;

FIG. 6 illustrates a side view of the tool;

FIG. 7 illustrates a back view of the tool;

FIG. 8 illustrates a front view of the tool;

FIG. 9 illustrates the manual mode tool operating in the stake installation shown in FIG. 1 and FIG. 2; and

FIG. 10 illustrates the pressurized mode tool operating in the stake installation shown in FIG. 1 and FIG. 2.

### DETAILED DESCRIPTION OF THE INVENTION

Embodiments of the present invention provide an improved stake puller that overcomes the limitations of the existing devices. The following description is presented to enable one of ordinary skill in the art to make and use the invention and is provided in the context of a patent application and its requirements. In the following text, the terms stake, post, rod, peg, and the like, whether metal, wood, plastic or other material may be used interchangeably (unless the context indicates otherwise” and may refer to any of a variety of different retaining structures or marker driven into a substrate, such as the earth or the like.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

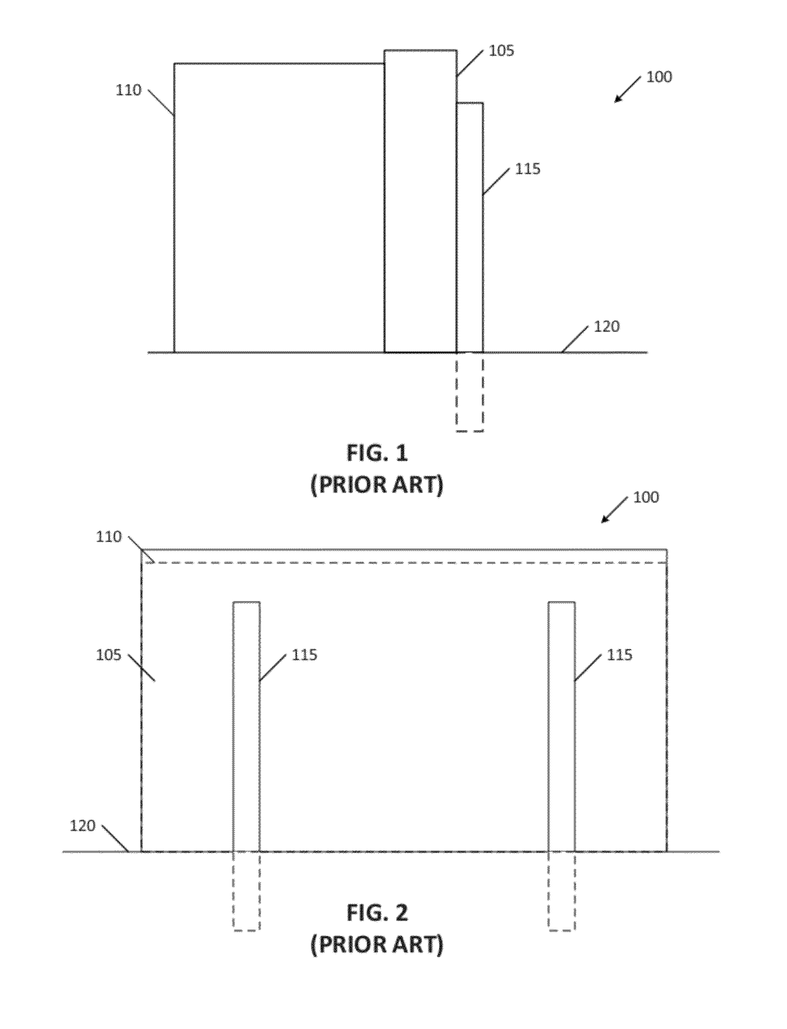

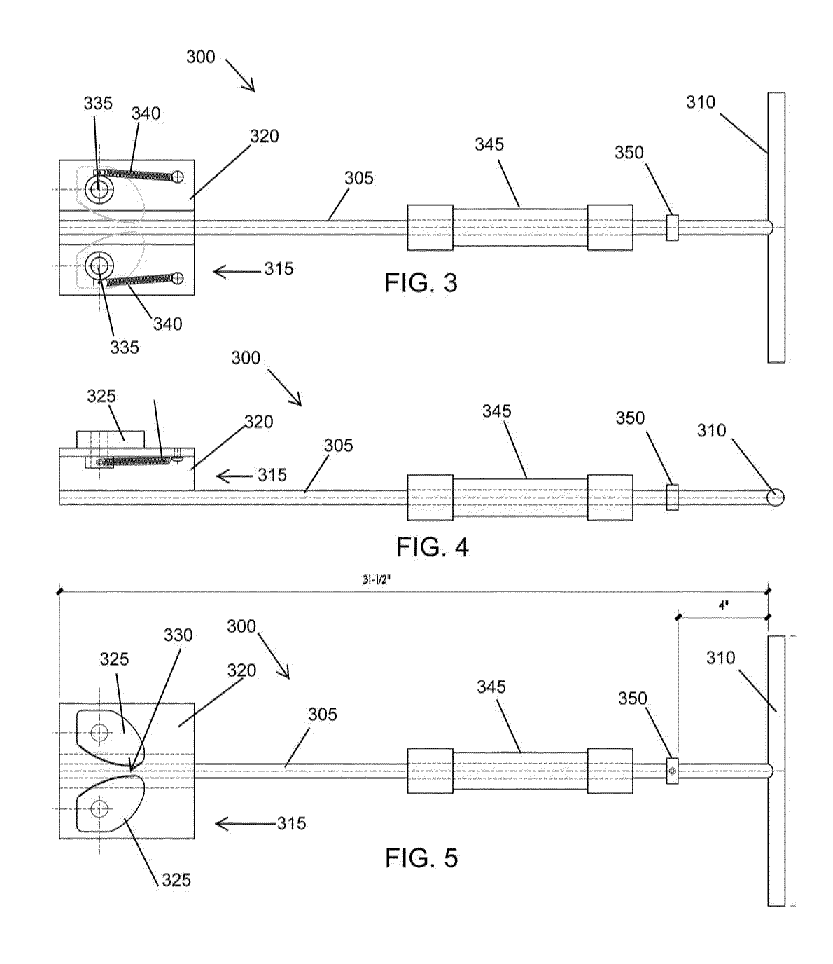

FIG. 3-FIG. 5 illustrate a preferred embodiment for a manual mode stake extraction tool 300, such as may be used in the stake installation shown in FIG. 1 and FIG. 2. FIG. 3 illustrates a back view of tool 300, FIG. 4 illustrates a side view of tool 300, and FIG. 5 illustrates a front view of tool 300. Tool 300 includes an elongated shaft 305 having a cross-handle (e.g., a T-shape handle or the like) attached at a proximal end of shaft 305 and a stake-engaging head 315 attached at a distal end of shaft 305.

Shaft 305 is preferably made of hardened steel to resist deformation/destruction as used herein. Shaft 305 is preferably cylindrical though it may have a square, oval, or other cross-section (including a rectilinear elongated plate structure and the like). Handle 310 is preferably “T” shaped to enable the user to pull, and/or rock a stake engaged by stake-engagement head 315. Other implementations may employ a different handle style appropriate for its intended use.

Stake-engagement head 315 includes a plate 320 affixed to the distal end of shaft 305. A pair of opposing biased cammed structures 325 form jaws with a special gripping channel 330. Cammed structures 325 are pivotally coupled at pivots 335 and biased together with springs 340. Channel 330 is exposed and open permitting a stake to be easily gripping with only limited purchase available due to the stake being abutted against the perpendicular wall of the form.

Channel 330, which receives the stake to be extracted, engages lateral surfaces of the stake as it is disposed in the substrate. Cammed structures 325 provide a variable width to channel 330, the channel expanding to receive the stake and then closing on the lateral surface due to springs 340. Stake-engagement head 315 is configured so that the stake to be extracted has a longitudinal axis (the axis running a length of the stake) generally parallel to a longitudinal axis of shaft 305. (The axes are displaced by a thickness of plate 320.) Further, cammed structures 325 are configured so that a longitudinal force applied to the longitudinal axis of shaft 305 (such as, for example, pulling on handle 310 directly away from the distal end of shaft 305) communicates a similar longitudinal extracting force to any stake gripped within channel 330. This longitudinal force also operates to reduce the width of channel 330 which increases the lateral gripping force on the stake within the channel. In this way channel 330 self-adjusts for differing diameter stakes and increases gripping strength the more force needed to extract a stake.

In some instances, a user will benefit from application of a greater longitudinal force than can be readily applied by a user pulling on handle 310. Tool 300 includes a slide hammer enabling a user to drive difficult-to-remove stakes from the substrate. A slide hammer, or similar structure, is coupled to shaft 305 to enhance application of extracting longitudinal forces. For example, the slide hammer of the preferred embodiment is constructed of a hammer 345 slidingly engaged to shaft 305 in-between handle 310 and stake-engagement head 315. Hammer 345 slides smoothly along the shaft and may be implemented complementary to any cross-section for shaft 305. Coupled to shaft 305 near handle 310 is an anvil 350. Anvil 350 is fixed in location and resists relocation when struck with significant force by hammer 345. In this way, the hammering force applied by quickly moving hammer 345 to strike anvil 350 is communicated to shaft 305 as another longitudinal force. This longitudinal is, in turn, transferred/communicated to a stake engaged by stake-engagement head 315 and operates to longitudinally drive the stake from the substrate, freeing it for removal.

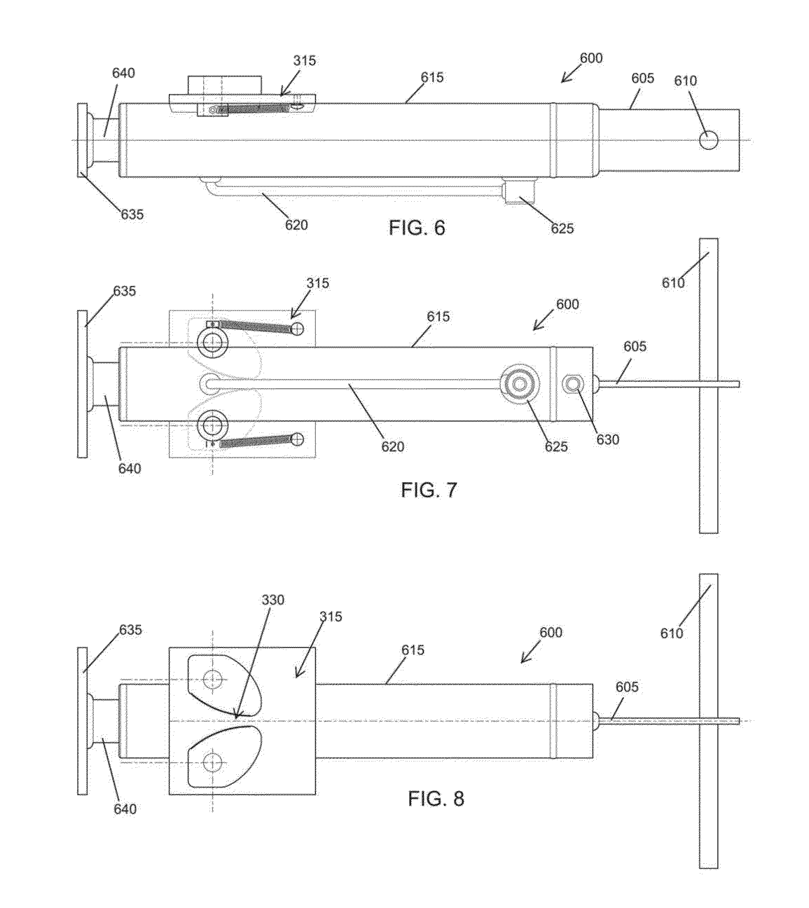

FIG. 6-FIG. 8 illustrate a preferred embodiment for a pressurized mode stake extraction tool 600, such as may be used in the stake installation shown in FIG. 1 and FIG. 2. FIG. 6 illustrates a side view of tool 600, FIG. 7 illustrates a back view of tool 600, and FIG. 8 illustrates a front view of tool 600. Tool 600 includes an elongated shaft 605 having a cross-handle (e.g., a T-shape handle or the like) attached at a proximal end of shaft 605 and a stake-engaging head 315 attached at a distal end of shaft 605.

Shaft 305 is preferably made of hardened steel to resist deformation/destruction as used herein (because of the potentially large forces applied by the pressurized (e.g., hydraulic/pneumatic) system, shaft 605 is preferably an elongated plate, though it may have other cross-section. Handle 610 is preferably similar to handle 310 though its manner of coupling to shaft 605 differs. Handle 610 is “T” shaped to enable the user to pull, and/or rock a stake engaged by stake-engagement head 315. Other implementations may employ a different handle style appropriate for its intended use. Stake-engagement head 315 is preferably the same as shown in FIG. 3 through FIG. 5 in structure and operation.

Tool 600 includes a pressure-driven subsystem 615 that couples shaft 605 to stake-engagement head 315. Subsystem 615 includes a tube 620 for fluid flow between chambers of the pressure-motor, a control valve 625, a pressure-equalization valve 630, a base 635 and a piston 640. Subsystem 615 contemplates both hydraulic (the fluid is a liquid) and pneumatic (the fluid is a gas (e.g., air)) implementations. There are many ways to implement a pressure-driven “motor” that typically includes different chambers responsive to fluid flow to effectuate mechanical motion. Tool 600 is most preferably implemented using a hydraulic fluid communicated through tube 620 from valve 625. Fluid flow controls an extension/retraction of piston 640. By securing base 635 near the stake to be extracted (directly on the substrate, an edge of a perpendicular wall abutting the stake (e.g., form 105), or other stable foundation) and extending piston 640, stake-engagement head 315 is moved away from base 635 and thereby extracts the stake by application of a transferred longitudinal axial force.

To increase portability and maneuverability of tool 600, a fluid reservoir and pump are not integrated into tool 600. Tool 600 receives pressurized fluid through a hose or tube coupled to valve 625, with the pressurized fluid provided by an additional machine having such a reservoir and pump. Air compressors and excavation machinery is commonly available/accessible at worksites employing stakes as described herein. Many types of excavation machinery include externally accessible hydraulic lines. Such hydraulic systems are typically controlled by an operator located in a cab of the machinery. In one implementation, tool 600 would require two people for efficient extraction of a stake. One person locates a stake, positions tool 600 to engage the stake and properly secure the base, and the other person actuates the hydraulic system to drive the piston and extract the stake. In another implementation, a version of a control system includes manual operation of a control valve to enable a single user to not only locate and position the tool, but to also actuate the piston.

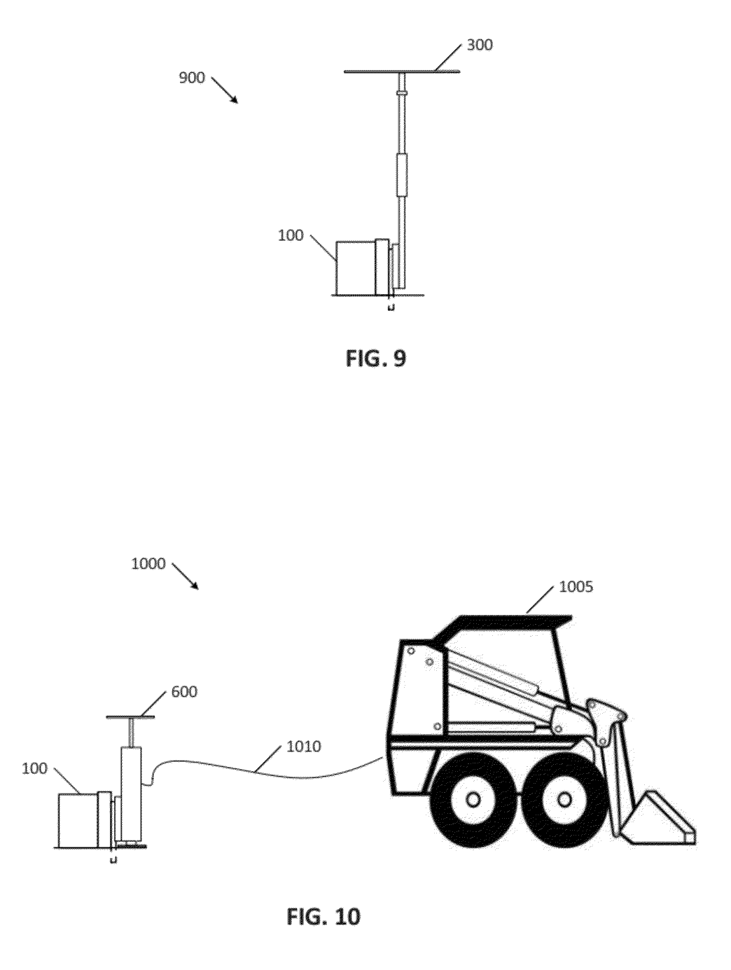

FIG. 9 illustrates an operational scenario 900 in which manual mode tool 300 shown in FIG. 3-FIG. 5 operates in the stake installation shown in FIG. 1 and FIG. 2. As shown in scenario 900, tool 300 does not rely on any fulcrum, pivot, support or the like (except of course the user/operating holding tool 900 in proper location). The user is able to extract certain stakes just by operating the handle of tool 300 (e.g., pulling, rocking, and the like). For stakes requiring more force, the user may operate the slide hammer to drive stakes out of the ground. The user holds tool 300 in position with one hand and operates the slide hammer with the other, effectively and efficiently extracting stakes, including hard to reach stakes that do not permit much access.

FIG. 100 illustrates an operational scenario 1000 in which pressure-driven tool 600 shown in FIG. 6-FIG. 8 operates in the stake installation shown in FIG. 1 and FIG. 2. As shown in scenario 1000, tool 600 may be operated similarly to tool 300 to manually extract some stakes. In those cases where the user would used the slide hammer of tool 300, the user actuates the pressurized piston of tool 600. Thus, the user is able to extract certain stakes just by operating the handle of tool 300 (e.g., pulling, rocking, and the like). For stakes requiring more force, the user may operates the pressure system to extract the stakes from the ground. The user holds tool 600 in position and the pressure system is actuated, effectively and efficiently extracting stakes. Pressurized fluid is provided from a fluid reservoir and pump integrated into an independent piece of equipment 1005 (e.g., a piece of excavation machinery, air compressor, or the like) to tool 600 via a hose 1010.

As noted herein, the system and process are most preferably implemented in manual and/or pressurized tools. Preferably longitudinal axial forces applied to a shaft of the tool are closed transferred to longitudinal axial extraction forces for the stake, essentially pulling it straight out (least resistance and maximum extractive force).

The system and methods above has been described in general terms as an aid to understanding details of preferred embodiments of the present invention. Other preferred embodiments of the present include the described application for stake extraction in other contexts. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A stake puller for extracting a stake from a portion of a substrate wherein the stake is abutted against a perpendicular wall that thereby exposes a side portion of the stake opposite of the perpendicular wall between the portion of the substrate and an exposed top of the stake, the puller comprising:
a shaft having a distal end and a proximal end;
a cross-handle coupled to said proximal end; and
a stake-engaging head, coupled to said distal end, engaging the exposed side portion of the stake between the portion of the substrate and the exposed top from a direction opposite of the perpendicular wall wherein a longitudinal axis of said shaft is generally parallel to a longitudinal axis of the stake when said stake-engaging head engages the exposed side portion of the stake.

2. The stake puller of claim 1 wherein said stake-engaging head includes a generally planar plate generally parallel to said longitudinal axis of said shaft and a shaft gripper coupled to a face of said plate and defining a gripping channel with said shaft gripper configured to apply a lateral gripping force using said gripping channel, said gripping force increases in response to a longitudinal force applied to said shaft in a direction away from the portion of the substrate.

3. The stake puller of claim 2 wherein said longitudinal force is applied by pulling upwardly on said handle away from the portion of the substrate generally parallel to said longitudinal axis of the stake.

4. The stake puller of claim 2 wherein said shaft gripper includes a first biased cammed surface pivotally coupled to said plate with said cammed surface cooperating with an opposing surface to define said gripping channel therebetween.

5. The stake puller of claim 4 wherein said opposing surface is a second biased cammed surface.

6. The stake puller of claim 1 further comprising:
a slide hammer, slidingly coupled to said shaft between said stake-engaging head and said cross-handle, and
an anvil coupled to said shaft proximate said handle wherein operation of said slide hammer sliding along said shaft and engaging said anvil communicates a longitudinal hammering force to said shaft which in turn communicates a longitudinal extracting force to the longitudinal axis of the stake away from the portion of the substrate.

7. The stake puller of claim 6 wherein said stake-engaging head includes a generally planar plate generally parallel to said longitudinal axis of said shaft and a shaft gripper coupled to a face of said plate and defining a gripping channel with said shaft gripper configured to apply a lateral gripping force using said gripping channel, said gripping force increases in response to a longitudinal force applied to said shaft in a direction away from the portion of the substrate.

8. The stake puller of claim 7 wherein said longitudinal force is applied by pulling upwardly on said handle away from the portion of the substrate generally parallel to said longitudinal axis of the stake or by operating said slide hammer.

9. The stake puller of claim 7 wherein said shaft gripper includes a first biased cammed surface pivotally coupled to said plate with said cammed surface cooperating with an opposing surface to define said gripping channel therebetween.

10. The stake puller of claim 9 wherein said opposing surface is a second biased cammed surface.

11. The stake puller of claim 1 further comprising a base coupled to said distal end extending past said stake-engaging head away from said proximal end and a pressure-powered subsystem coupling said stake-engaging head to said shaft, wherein said pressure-powered subsystem includes a motor to drive said stake-engaging head from a position proximate said distal end towards said proximal end along said shaft.

12. The stake puller of claim 11 wherein said pressure-powered subsystem includes a hydraulic machine, said motor includes a hydraulic cylinder and piston responsive to hydrostatic transmission of a fluid from a reservoir through a control valve.

13. The stake puller of claim 11 wherein said pressure-powered subsystem includes a pneumatic machine, said motor includes a pneumatic cylinder and piston responsive to pneumatic transmission of a fluid from a reservoir through a control valve.

14. The stake puller of claim 12 wherein said control valve is integrated into said pressure-powered subsystem, wherein said reservoir is included as part of a hydraulic system of a construction machine, and wherein said reservoir is communicated to said pressure-powered subsystem through a hose coupled to said machine.

15. A method for extracting a stake from a portion of the substrate wherein the stake is abutted against a perpendicular wall that thereby exposes a side portion of the stake opposite of the perpendicular wall between the portion of the substrate and an exposed top of the stake, the method comprising the steps of:
a) engaging the exposed side portion of the stake between the portion of the substrate and the exposed top from a direction opposite of the perpendicular wall with an engagement head coupled to a distal end of a shaft with a longitudinal axis of said shaft generally parallel to a longitudinal axis of the stake;
b) applying a longitudinal force to said shaft directed away from the portion of the substrate; and
c) transferring said longitudinal force to the stake through said coupling of said engagement head to said shaft.

16. The method of claim 15 wherein said applying step b) further comprises the steps of:
b1) applying an extractive force to a cross-handle coupled to a proximal end of said shaft; and
b2) transferring said extractive force to said shaft as said longitudinal force.

17. The method of claim 15 wherein said applying step b) further comprises the steps of:
b1) operating a slide hammer slidingly engaged with said shaft to impact an anvil coupled to said shaft proximate a proximal end of said shaft to produce an extractive force; and
b2) transferring said extractive force to said shaft as said longitudinal force.

18. The method of claim 15 wherein said applying step b) further comprises the steps of:
b1) engaging a support area proximate the portion of the substrate with a base coupled to said distal end of said shaft that extends beyond said engagement head and away from a proximal end of said shaft; and
b2) operating a pressure-powered subsystem that couples said engagement head to said shaft to move said engagement head from said base towards a proximal end of said shaft to apply said longitudinal force to said shaft.

19. The method of claim 15 wherein said engaging step a) further comprises the steps of a1) capturing the stake within a gripping channel of said engagement head wherein said gripping channel has a variable width and a2) applying a gripping force to the stake in inverse relationship to said variable width, and wherein said transferring step c) further comprises the step of c1) reducing said variable width in direct relationship to said longitudinal force.

20. A stake puller for extracting a stake from a portion of a substrate, the puller comprising:
a shaft having a distal end and a proximal end;
a cross-handle coupled to said proximal end; and
a stake-engaging head, coupled to said distal end, engaging a side portion of the stake between the portion of the substrate and a top of the stake wherein a longitudinal axis of said shaft is generally parallel to a longitudinal axis of the stake when said stake-engaging head engages said side portion of the stake.
